(19) United States
(12) Patent Application Publication
(10) Pub. No.: US 2013/0325708 A1
(43) Pub. Date: Dec. 5, 2013

(54) APPLICATION ACCESS MANAGEMENT METHOD AND APPARATUS

(71) Applicants: Alok Sharma, Lisle, IL (US); Yigang Cai, Naperville, IL (US)

(72) Inventors: Alok Sharma, Lisle, IL (US); Yigang Cai, Naperville, IL (US)

(21) Appl. No.: 13/487,439

(22) Filed: Jun. 4, 2012

(51) Int. Cl. G06Q 20/14

(52) U.S. Cl. 705/40

(57) ABSTRACT

An exemplary application access manager apparatus includes at least one computing device. A digital data storage comprises a relationship establishment program, an application access program and a revenue allocation program. A processor is configured to execute the relationship establishment program to apply a plurality of rules that govern a relationship between a user desiring access to at least one application and at least one of a service provider or an application provider. The processor is configured to execute the application access program to obtain information regarding any access by the user of the application. The processor is configured to execute the revenue allocation program to determine how to charge the user for any access to the application and to allocate any revenue to at least one of the service provider or the application provider.

### BACKGROUND

Wireless communication capabilities have expanded significantly. For example, smart phone technology allows wireless customers to obtain and use a variety of applications.

One challenge associated with providing more applications includes attempting to access data and features in operator networks. Such information can be critical for developing a new application or enhancing an existing application. One system that allows operators to make features in their networks available to application developers and content providers in a secure way is Alcatel-Lucent' s AES (Application Exposure Suite). With the introduction of the AES, developers are provided with application programming interface (API) access that provides the consistency needed for developing applications that can be used on a widespread basis. The AES facilitates service providers maintaining control over developer's use of network features and information. The AES also provides security over the exposure of network capabilities during the developing process. Service providers can now expose their own APIs and network capabilities to developers, which allows for further proliferation of applications.

### SUMMARY

An exemplary application access manager apparatus includes at least one computing device having a digital data storage and a processor associated with the digital data storage. The digital data storage comprises a relationship establishment program, an application access program and a revenue allocation program. The processor is configured to execute the relationship establishment program to apply a plurality of rules that govern a relationship between a user desiring access to at least one application and at least one of a service provider through which the user obtains the desired access or an application provider that provides the application. The processor is configured to execute the application access program to obtain information regarding any access by the user of the application. The processor is configured to execute the revenue allocation program to determine how to charge the user for any access to the application and to allocate any revenue from the user to at least one of the service provider or the application provider according to at least one of the plurality of rules.

An exemplary method of managing application access includes establishing a relationship between a user desiring access to at least one application and at least one of a service provider through which the user obtains the desired access or an application provider that provides the application. The established relationship comprises a plurality of rules governing user access to the application. A determination is made how to charge the user for any access to the application. A determination is also made how to allocate any revenue from the user to at least one of the service provider or the application provider according to at least one of the plurality of rules of the established relationship.

The various features and advantages of a disclosed example will become apparent to those skilled in the art from the following detailed description. The drawings that accompany the detailed description can be briefly described as follows.

### BRIEF DESCRIPTION OF THE DRAWINGS

FIG. 1 schematically illustrates an application access arrangement that includes an application access manager apparatus designed according to an embodiment of this invention.

FIG. 2 schematically illustrates selected features of an example application access manager apparatus.

FIG. 3 is a flowchart diagram summarizing an example approach.

FIG. 4 schematically illustrates selected features and functions of an example application access manager apparatus.

### DETAILED DESCRIPTION

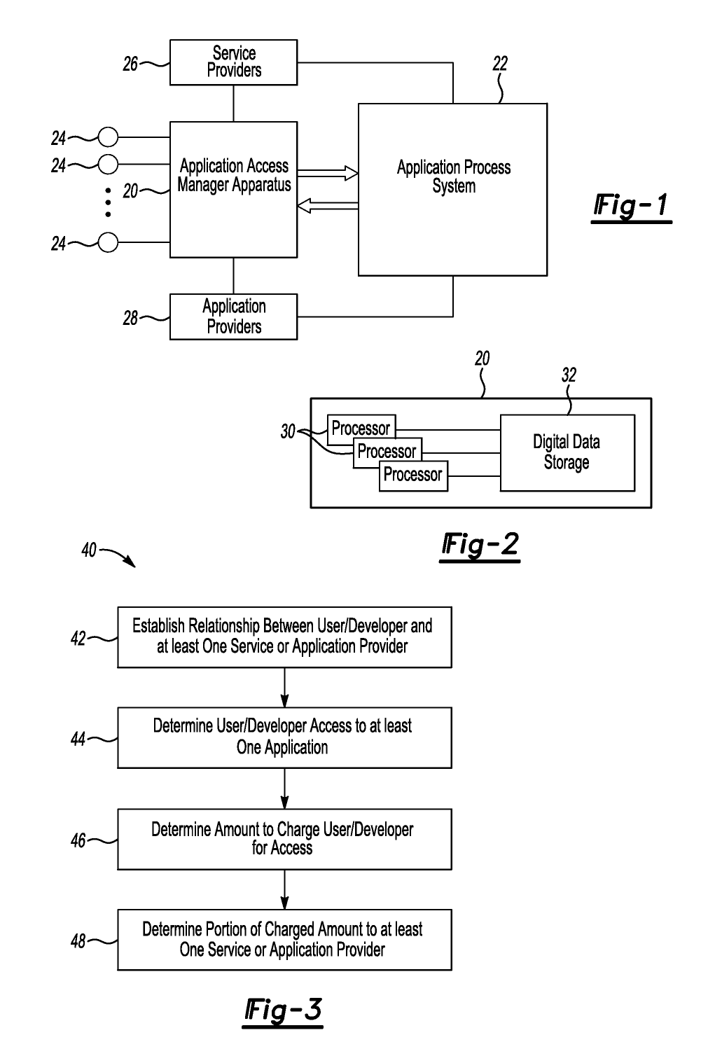

FIG. 1 schematically shows an application access manager apparatus 20 that is useful for facilitating use of an application access system 22. In one example, the application access system 22 comprises one or more features of the application exposure suite (AES) provided by Alcatel-Lucent. Other examples include other application access systems.

The application access manager apparatus 20 facilitates a plurality of users 24 utilizing the application access system 22 for a variety of purposes. In the following description, an example user 24 who is a developer that desires access to one or more applications, application programming interfaces (APIs) or network functionalities will be considered. Those skilled in the art who have the benefit of this description will realize the variety of types of users and how their use of an application access system 22 can be facilitated by an application access manager apparatus 20 having the features of the disclosed example.

The application access manager apparatus 20 facilitates establishing a relationship between the users 24, service providers 26 and application providers 28. The established relationship allows for use of the application access system 22 according to a plurality of rules that will govern the relationship between the various entities using the application access system 22. The application access manager apparatus 20 may also facilitate establishing relationships between the service providers 26 and the provider of the application access system 22, relationships between application providers 28 and the provider of the application access system 22 or relationships between service providers 26 and application providers 28. The following description will focus on the relationships between a user 24 and at least one of the service providers 26 or at least one of the application providers 28 as an example for discussion purposes.

FIG. 2 schematically shows selected portions of an application access manager apparatus 20 that is useful with an embodiment of this invention. In this example, the application access manager apparatus 20 comprises at least one computing device having one or more processors 30. A digital data storage 32 is associated with the processors 30. The digital data storage 32 in this example includes a plurality of programs that facilitate the various functions provided by the application access manager apparatus 20. In this example, the digital data storage includes a relationship establishment program, an application access program and a revenue allocation program. One or more of the processors 30 is configured to execute one or more of those programs.

While schematically shown as a single computing device in FIG. 2, the application access manager apparatus 20 may be realized through the coordination of a plurality of remotely located devices or a cloud computing arrangement, for example. Given this description, those skilled in the art will realize what arrangement of computing hardware, software, firmware or combination of these will best suit their particular needs for realizing the functions of the example application access manager apparatus 20.

FIG. 3 includes a flowchart diagram 40 that summarizes an example approach for managing application access. At 42, a relationship between a user 24, such as an application developer, and at least one of the service providers 26 or application providers 28 is established. The relationship includes a plurality of rules that govern the user's use of the application access system 22. At 44, a determination is made regarding any access by the user 24 to at least one application available through the application access system 22. At 46, a determination is made regarding an amount to charge to the user 24 for the access to the application. The amount charged may be based upon the type of access to the application, whether the access involves utilizing features of a service provider's network available through the application access system 22, a data rate consumed by the user, or other access or use quantities specified in the relationship between the user and the corresponding provider. At 48, a determination is made regarding whether any portion of the amount charged to the user should be allocated to a service provider 26 or application provider 28. This approach allows for the provider of the application access system 22, the service providers 26, the application providers 28 or a combination of them to obtain revenue resulting from user access to that which is made available through the application access system 22.

The application access manager apparatus 20 facilitates establishing a business relationship between various users of the application access system 22. It has the ability to extract transaction information available from the exposure engines of the application access system 22 to monitor and manage application access. The application access manager apparatus 20 also has the ability to obtain and store information regarding applications as they are used by developers for enhancing them or for developing new applications based on them.

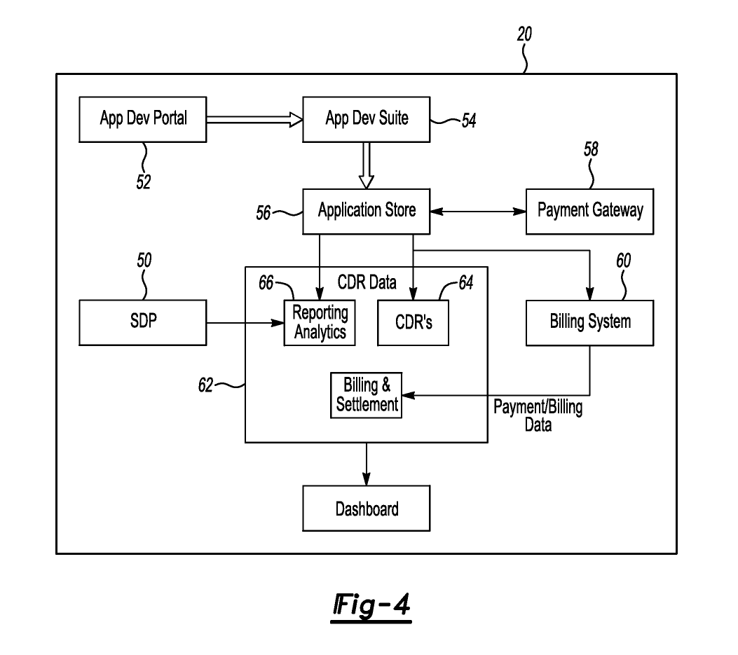

FIG. 4 schematically illustrates various functions provided by an example application access manager apparatus 20. A software development platform (SDP) 50 allows a provider to set up rules that will govern the relationship between that provider and a user. For example, a service provider may establish a rule that governs how the user will be charged based upon bandwidth consumption or a number of application access operations. The provider may also arrange for user access to particular network functionality exposed through the application access system 22.

In one example, the SDP 50 comprises a programming interface that allows a provider to enter programming information or code to define the parameters or rules of the relationship that provider intends to establish with users or developers. Another example SDP 50 provides a template of relationship formats or rules that may be selected by a provider that intends to participate in the application access system 22 and to allow users or developers access to that which the provider makes available through the application access system 22. The SDP 50 in one example provides a plurality of templates to providers for establishing how that provider intends to structure a potential relationship with one or more users or developers.

An application development portal 52 provides the interface that allows developers to gain access to the application access system 22. The application development portal 52 facilitates establishing the relationship between the developer and a provider by presenting the developer with a template or sample contract that the developer must complete to gain the desired access. The application development portal 52 gathers sufficient information from a user or developer for making a determination whether that user or developer is qualified to obtain desired access. The application development portal 52 facilitates establishing the relationship between the user and the corresponding provider.

An application development suite 54 utilizes information regarding the relationship established between the provider and the user for determining which applications and related features are available to a particular user. The application development suite 54 facilitates a user signing up for access to any application that the user intends to access. The application development suite 54 also allows a user to sign up for particular network functionality or information access. In one example, one or more of the processors 30 (FIG. 2) is configured to execute the relationship establishment program from the digital data storage 32 (FIG. 2) for realizing the features provided by the application development portal 52 and the application development suite 54.

An application store 56 represents the applications that are available to a user. A payment gateway 58 tracks the access to any of the applications by any user. Some user-provided relationships will include charging the user based upon application access. The payment gateway 58 tracks such information, which is useful to a processor 30 executing the revenue allocation program from the digital data storage 32 for purposes of charging a user according to one or more rules governing the relationship between that user and one or more of the providers. A billing system interface 60 facilitates directing charges or payments to the appropriate parties.

An information module 64 represents the functionality of one or more processors 30 executing the application access program from the digital data storage 32 of the application access manager apparatus 20. In this example, the information module 64 collects information regarding application access through the application store 56. The access information is represented by call data records (CDRs) in the illustration. Information from the SDP 50 provides guide lines for information gathering and reporting according to the relationship between a particular user and a particular provider. A reporting analytics portion 66 provides information to a user or provider regarding access according to the rules governing the corresponding relationship.

In some examples, the reporting analytics portion 66 tracks information regarding application status over time. For example, an application may be added to the application store by an application provider. That application may be accessed by a variety of developers and be modified over time. Those modifications are tracked by the reporting analytics portion 66. The example application access manager apparatus 20 has the capability of providing detailed records regarding application access and development over time. Reports can be provided to developers and providers regarding any updates made to an application so that concerned parties have real-time application status updates. The information module 62 in this example also provides billing and settlement information regarding charges to users, payments from users, revenue allocations to providers or a combination of these.

The illustrated example facilitates a dashboard 70 that presents an interface to providers for tracking the status of any use of the information or functionality that the provider makes available through the application access system 22. The dashboard 70 provides a single view of business-critical information and any updates to any applications or application programming interfaces (APIs) of concern to a particular provider.

The example application access manager apparatus 20 facilitates relationships between users who desire access to applications and providers that make applications, APIs and network functionality available. The application access manager apparatus 20 addresses the needs for a variety of types of relationships between different providers and different users. The application access manager apparatus 20 facilitates establishing many relationships having varied and distinct rules governing those relationships, which allows for use of the application access system 22 in a manner that meets the needs of a variety of different users and providers. The application access manager apparatus 20 facilitates establishing a relationship according to terms agreed upon by providers and users, extracts information regarding use of the application access system 22 (e.g., application access), extracts information regarding application status, facilitates obtaining payment from users and allocating revenue to providers in a way that allows for service providers and application providers to obtain revenue based upon eventual commercialization of newly developed applications and modified applications even when those new developments and modifications are made by third party developers or users.

The preceding description is exemplary rather than limiting in nature. Variations and modifications to the disclosed examples may become apparent to those skilled in the art that do not necessarily depart from the essence of this invention. The scope of legal protection given to this invention can only be determined by studying the following claims.

We claim:

1. An application access manager apparatus, comprising:
at least one computing device including a digital data storage and a processor associated with the digital data storage;
the digital data storage comprising a relationship establishment program, an application access program and a revenue allocation program;
the processor being configured to execute the relationship establishment program to apply a plurality of rules that govern a relationship between
a user desiring access to at least one application and
at least one of a service provider through which the user obtains the desired access or an application provider that provides the at least one application;
the processor being configured to execute the application access program to obtain information regarding any access of the at least one application by the user; and
the processor being configured to execute the revenue allocation program to determine how to charge the user for any access to the at least one application and to allocate any revenue from the user to at least one of the service provider and the application provider according to at least one of the plurality of rules.

2. The application access manager apparatus of claim 1, wherein the processor is configured to execute the relationship establishment program to allow at least one of the application provider or the service provider to establish one or more of the rules that govern the relationship between the at least one provider and the user.

3. The application access manager apparatus of claim 1, wherein the processor is configured to execute the relationship establishment program to
present the user with at least one template that indicates information needed from the user;
obtain the information from the user; and
determine the plurality of rules that govern the relationship of the user and at least one of the providers.

4. The application access manager apparatus of claim 1, wherein the processor is configured to execute the relationship establishment program to present the user with a contract to be executed by the user as a prerequisite to obtaining any desired access to an application.

5. The application access manager apparatus of claim 1, wherein the processor is configured to execute the application access program to
obtain information regarding an amount of user access to the at least one application;
determine an amount to charge the user for the access; and
allocate at least some of the charged amount to at least one of the service provider and the application provider according to at least one of the plurality of rules that govern the relationship between the user and the at least one provider.

6. The application access manager apparatus of claim 1, wherein the processor is configured to execute the application access program to determine any activity of the user accessing the at least one application; and
provide an indication of the determined activity.

7. The application access manager apparatus of claim 6, wherein the processor is configured to execute the application access program to provide the indication of the determined activity to any of the user, the service provider or the application provider.

8. The application access manager apparatus of claim 6, wherein the processor is configured to execute the application access program to
provide an indication of a history of any determined activity of any user accessing any application that is accessible through the application access manager apparatus.

9. The application access manager apparatus of claim 6, wherein the processor is configured to execute the revenue allocation program to
determine an amount to charge the user based on the indication of the determined activity; and
determine a portion of the charged amount to allocate to at least one of the service provider and the application provider.

10. The application access manager apparatus of claim 6, wherein the processor is configured to execute the revenue allocation program to
determine an amount of commercialization of an application that has been at least partially created or modified by the user; and
determine an amount of revenue to allocate to at least one of the service provider and the application provider based on the determined amount of commercialization.

11. A method of managing application access, comprising:
using at least one computing device including a digital data storage and a processor associated with the digital data storage for
(A) establishing a relationship between
a user desiring access to at least one application and
at least one of a service provider through which the user obtains the desired access or an application provider that provides the at least one application,
the relationship comprising a plurality of rules governing user access to the at least one application;
(B) obtaining information regarding any access of the at least one application by the user;
(C) determining how to charge the user for any access to the at least one application; and
(D) determining how to allocate any revenue from the user to at least one of the service provider and the application provider according to at least one of the plurality of rules.

12. The method of claim 11, comprising
allowing at least one of the application provider or the service provider to establish one or more of the rules that govern the relationship between the at least one provider and the user.

13. The method of claim 11, comprising
presenting the user with at least one template that indicates information needed from the user;
obtaining the information from the user; and
determining the plurality of rules that govern the relationship of the user and at least one of the providers.

14. The method of claim 11, comprising presenting the user with a contract to be executed by the user as a prerequisite to obtaining any desired access to an application.

15. The method of claim 1, comprising
obtaining information regarding an amount of user access to the at least one application;
determining an amount to charge the user for the access; and
allocating at least some of the charged amount to at least one of the service provider and the application provider according to at least one of the plurality of rules that govern the relationship between the user and the at least one provider.

16. The method of claim 11, comprising
determining any activity of the user accessing the at least one application; and
providing an indication of the determined activity.

17. The method of claim 16, comprising providing the indication of the determined activity to any of the user, the service provider or the application provider.

18. The method of claim 16, comprising providing an indication of a history of any determined activity of the user accessing an application.

19. The method of claim 16, comprising
determining an amount to charge the user based on the indication of the determined activity; and
determining a portion of the charged amount to allocate to at least one of the service provider and the application provider.

20. The method of claim 16, comprising
determining an amount of commercialization of an application that has been at least partially created or modified by the user; and
determining an amount of revenue to allocate to at least one of the service provider and the application provider based on the determined amount of commercialization.
